(19) United States
(12) Patent Application Publication
(10) Pub. No.: US 2004/0188577 A1
(43) Pub. Date: Sep. 30, 2004

(54) Shower pipe clamp for a shower organizer shelf

(76) Inventor: Franklin G. Gaderick, Greenwich, CT (US)

Correspondence Address: Alfred E. Miller, 406 W. Putnam Ave., Greenwich, CT, 06830, US

(21) Appl. No.: 10/393,787

(22) Filed: Mar. 24, 2003

(51) Int. Cl. F16B 1/00; E04G 3/00

(52) U.S. Cl. 248/230.1

(57) ABSTRACT

A shower pipe clamp for a shower organizer shelf supporting personal care items which is generally used in a shower. The clamp is manually operated to positively grasp the entire circumference of a shower pipe behind the showerhead and prevents the shelf from tipping.

The present invention relates to a shower organizer or shelf arrangement for supporting personal care products such as soap, shampoo, shaving equipment and wash clothes in a shower stall or a tub and shower combination. Since the personal care items are weighty it is important to reliably secure the shower organizer to the shower pipe behind the showerhead so that the organizer will not be dislodged from the pipe thereby tipping or rotating causing the articles on the shelf of the organizer to fall off the shelf.

Shower shelves or caddies are known, for example in U.S. Pat. No. 3,789,996 to Stroh; U.S. Pat. No. 4,387,811 to Ragir et al.; U.S. Pat. No. 3,181,702 to Raphael and U.S. Pat. No. 3,923,162 to Hussey. All of these patents show shower shelves resting on the showerhead. The patent to Hussey shows a U-shaped lock member that utilizes a screw-type bolt fastener that passes through the eyes in the legs of the lock member in order to fasten the shelf to the pipe.

The other patents do not show or contemplate any positive gripping or clamping of the shower caddy to a standard shower pipe and therefore tipping or rotation of the shelf can occur. Those structures merely lightly clamp the shower shelf to their respective shower pipes.

It is a principal feature or object of the present invention to provide a positive gripping or clamping device for a shower organizer that is manually operated and requires no tools and which reliably grips the entire circumference of the shower pipe.

It is another object of the present invention to provide a positive clamping device for a shower pipe, which can be easily manually opened and removed from a shower pipe, if necessary.

A further object of the present invention is to fabricate the shower head pipe clamp of a slightly flexible plastic material which is impervious to water and moisture and which can be manually manipulated to be firmly attached to the shower organizer or caddy and will not move to a tilting position. The clamping device may be easily removed manually, and without the use of tools.

### DESCRIPTION OF THE DRAWINGS

In order that the invention may be more clearly understood, it will now be disclosed in greater detail with reference to the accompanying drawings in which:

FIG. 1 is a perspective view of the shower pipe clamp and shower organizer or shelf constructed in accordance with the teachings of my invention,

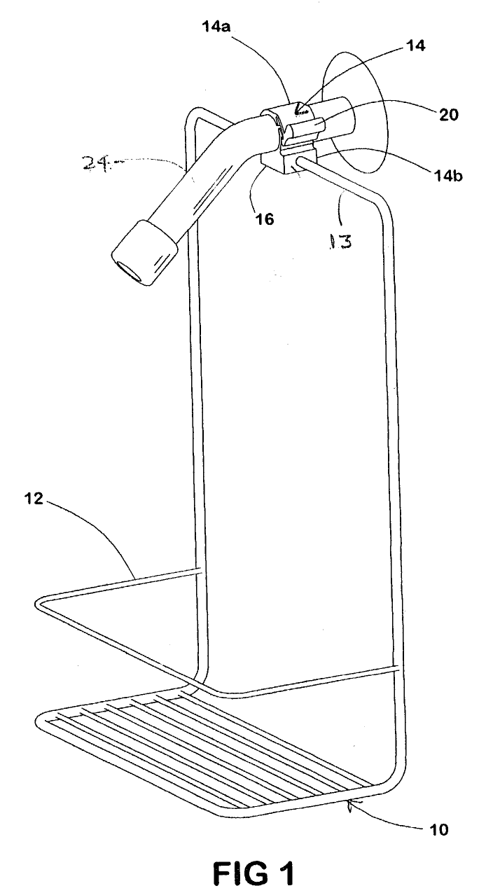

FIG. 2 is another perspective view of my invention with the shower pipe and showerhead removed,

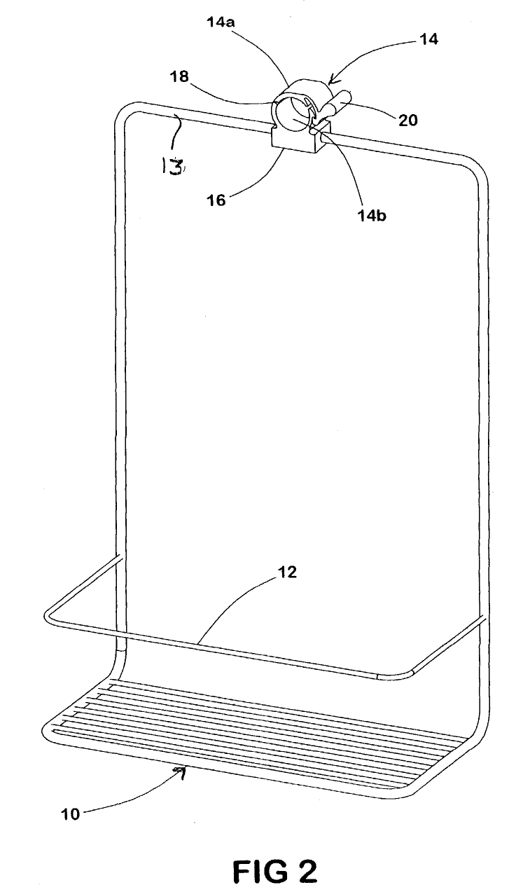

FIG. 3 is a side elevation view of positive gripping device for the shower organizer of my invention shown in open position in full lines and in closed position in dotted lines and

FIG. 4 is a perspective view of the positive gripping device of my invention

### DESCRIPTION OF THE PREFERRED EMBODIMENT

The shower organizer or caddy is referred to generally by the reference numeral 10 and has a bottom shelf 11 and a barrier 12 spaced above the bottom shelf for enclosing and maintaining personal care products on the shelf. The vertical support posts 13 of the organizer are connected by a horizontal bar 15.

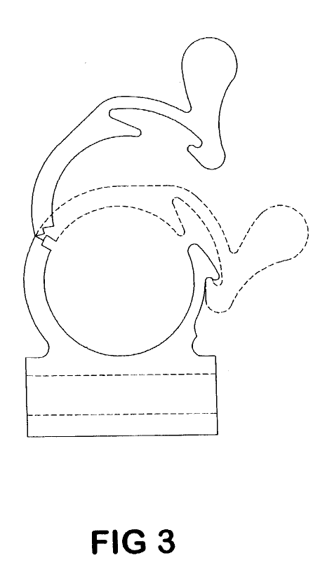

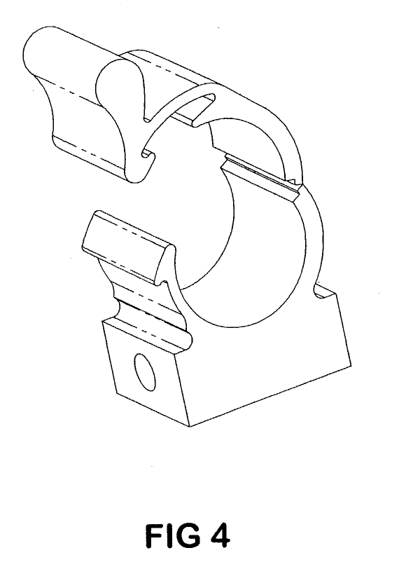

The clamping or gripping device for the shower pipe of the invention is referred to generally by the reference numeral 14 and is shown in more detail in FIGS. 3 and 4 of the drawings. The clamp 14 is fabricated preferably of a polypropylene thermoplastic resin and which is slightly flexible and has an upper part 14a and a lower part 14b connected together by hinge 18. The upper part 14a of the clamp is provided with a broad recess 17 and a handle portion 20, which at its opposite end from the hinge is provided with a hook 21. The clamp 14 is relatively stiff but has sufficient flexibility that when in the closed position, as seen in dotted lines in FIG. 3, the hook 21 on upper part 14a of the clamp 14 can be pulled around the catch 22 of the lower part 14b of the clamp by means of the handle 20 and engages in the recess behind the catch 22 in order to firmly grasp substantially all of the circumference of the shower pipe.

At the bottom of the clamp 14 is a mounting plate 16, preferably in a rectangular shape, having a through hole 16a. Thus, the horizontal bar 15 which is securely held in the hole 16a prevents the rotation of the bar 15 in the hole 16a, and maintains bottom shelf 11 in its horizontal, level position.

The showerhead clamp 14 can be clamped to the showerhead pipe manually and without the use of tools by grasping the handle 20 of the clamp 14 and pulling it down on the pipe until the hook 21 engages the recess behind the point 22.

While there has been described an embodiment of the present invention, it will be understood that various changes in the form and details of the device illustrated and its operation may be made by those skilled in the art without departing from the spirit of the invention. It is my intention, therefore to be limited only as indicated by the scope of the claims appended thereto.

What is claimed is:

1. A slightly flexible clamp for a shower organizer shelf for removably fastening said shelf to a shower head pipe comprising a first curvilinear member and a second curvilinear member, hinge means connecting said first and second curvilinear members, a handle and a hook at the end of said first member remote from said hinge means, a catch at the end of said second member remote from said hinge means, said first and second members being placed around and in contact with said shower head pipe whereby when said handle is pulled in a direction to engage said hook with said catch the clamp tightly engages substantially all of the outer surface of said shower head pipe, and means on said second member for attaching said clamp to said shower organizer shelf.

2. A clamp for a shower organizer shelf as claimed in claim 1 wherein said clamp is fabricated of a strong thermoplastic material.

3. A clamp for a shower organizer shelf as claimed in claim 2 wherein said thermoplastic material is polypropylene.

4. 1. A slightly flexible clamp for a shower organizer shelf for removably fastening said shelf to a shower head pipe comprising a first curvilinear member and a second curvilinear member, hinge means connecting said first and second curvilinear members, a handle and a hook at the end of said first member remote from said hinge means, a catch at the end of said second member remote from said hinge means, said first and second members being placed around and in contact with said shower head pipe whereby when said handle is pulled in a direction to engage said hook with said catch the clamp tightly engages substantially all of the outer surface of said shower head pipe, and means on said second member for attaching said clamp to said shower organizer shelf comprising a mounting member for said shower organizer shelf, said mounting member having a through hole, said shower organizer shelf having spaced upright posts, and a horizontal bar connecting to the ends of the upright posts and passing through said hole to suspend the shower organizer shelf from said clamp.

5. A clamp as claimed in claim 4 wherein said mounting member is rectangular.

6. A clamp as claimed in claim 1 wherein said first curvilinear member is provided with a recess, and said catch on said second curvilinear member is positioned in said recess when said hook engages said catch.
